(19) United States
(12) Patent Application Publication
(10) Pub. No.: US 2024/0329763 A1
(43) Pub. Date: Oct. 3, 2024

(54) Controller with Selectable Discrete and Variable Input Modes

(71) Applicant: Samsung Electronics Co., Ltd., Suwon-si (KR)

(72) Inventors: Ivan France, Saratoga, CA (US); Nigel Clarke, Sunnyvale, CA (US); Curtis Aumiller, San Jose, CA (US); Tara Sriram, Sunnyvale, CA (US); Shafae Ali, Mountain View, CA (US)

(21) Appl. No.: 18/528,359

(22) Filed: Dec. 4, 2023

Related U.S. Application Data
(60) Provisional application No. 63/456,149, filed on Mar. 31, 2023.

(51) Int. Cl. G06F 3/038; G06F 3/0354

(52) U.S. Cl. CPC G06F 3/038; G06F 3/03543; G06F 3/03547

(57) ABSTRACT

In one embodiment, an apparatus includes a controller trigger that includes an input surface configured to receive input based on movement of a finger of a user, the trigger having a range of motion along a trigger path. The apparatus further includes a mode selector configured to actuate movement of an intermediate switching component between a discrete-input mode and a variable-input mode. The intermediate switching component includes a moveable arm, and in the discrete input mode the moveable arm occupies at least a portion of the trigger path, thereby limiting the range of motion of the trigger; and in the variable input mode the moveable arm does not occupy the trigger path. The apparatus further includes a switch configured to receive input, in the discrete-input mode, based on a movement of the intermediate switching component, in response to a physical contact by the trigger.

### PRIORITY CLAIM

This application claims the benefit, under 35 U.S.C. § 119, of U.S. Provisional Patent Application No. 63/456,149 filed Mar. 31, 2023 and incorporated by reference herein.

### TECHNICAL FIELD

This application generally relates to a controller for an electronic device.

### BACKGROUND

Humans often interact with an electronic device through a controller. For example, a conventional computer mouse includes one or more buttons (such as a left and right button) and a position-tracking sensor (such as an optical sensor) to control the position of a pointer on a computer screen and to interact with graphical objects displayed on a screen. As another example, a gaming controller may include one or more buttons or joysticks for providing input to a computing device executing the game. Controllers may be wired or wireless, and in the latter case, may communicate with a computing device using wireless technologies such as Bluetooth, infrared, etc.

### BRIEF DESCRIPTION OF THE DRAWINGS

FIG. 1A and FIG. 1B illustrate an example embodiment of an apparatus that includes a trigger that can function in a variable-input mode and a discrete-input mode.

FIG. 2 illustrates an example in which an ISC contains a spring.

FIG. 3 illustrates an example in which an arm of an ISC rotates along a shaft in order to move into and out of a trigger's path.

FIG. 4 illustrates an example of an ISC that provides three input modes.

FIG. 5 illustrates an example computing system.

### DESCRIPTION OF EXAMPLE EMBODIMENTS

Controllers for computer devices, such as mice, gaming controllers, VR controllers, etc., typically use either variable (analog) input or discrete (digital) input. Variable input can take any value within a range, such as between 0 and 100, while discrete input has a small number of fixed states, such as on and off. For example, the conventional left and right mouse buttons typically are associated with discrete input, as those buttons either register no click (off) or a click (on). In contrast, a joystick is typically associated with variable input, for example because the input (e.g., the speed with which a game character moves) varies as a function of the joystick's distance from its rest position. Here, the references to analog and digital refer to input values, not to the electronics used to sense those values. For example, a variable input may be sensed using digital electronics. In such a case, values may be measured using discrete increments (such as 1), but do so over a large range (such as 0 to 255). Although values are discrete, the range of possible values is large enough that differences between incremental states is effectively unnoticeable and the input can be effectively considered a variable input.

Inputs on controllers can take several forms, such as buttons, joysticks, and triggers. Many controllers contain both variable and discrete input types (e.g., discrete-input buttons and variable-input triggers). Many different kinds of sensing technologies can be used with inputs. For example, potentiometers use variable electrical resistance to measure position. Potentiometers are typically very simple and low-cost, and are the one of the most common options for triggers and joysticks. As another example, Hall-effect sensors detect the strength of nearby magnetic fields. By placing a magnet in the moving trigger, and a hall effect sensor on the controller body, changing magnetic field strength can be converted into rotational position. Because potentiometers are analog in an electrical sense, their base resistance can vary, and can change with time as the physical contacts wear out. These sensors require periodic calibration, and typically rely on dead zones (where small motion is ignored until is passed a threshold value) to give consistent performance. Hall-effect sensors, on the other hand, do not require additional calibration or dead zones.

Embodiments of this disclosure describe an input that includes both a variable-input mode and a discrete-input mode. As explained more fully herein, various embodiments provide numerous benefits, such as increased longevity (e.g., due to minimizing the number of moving components), among others.

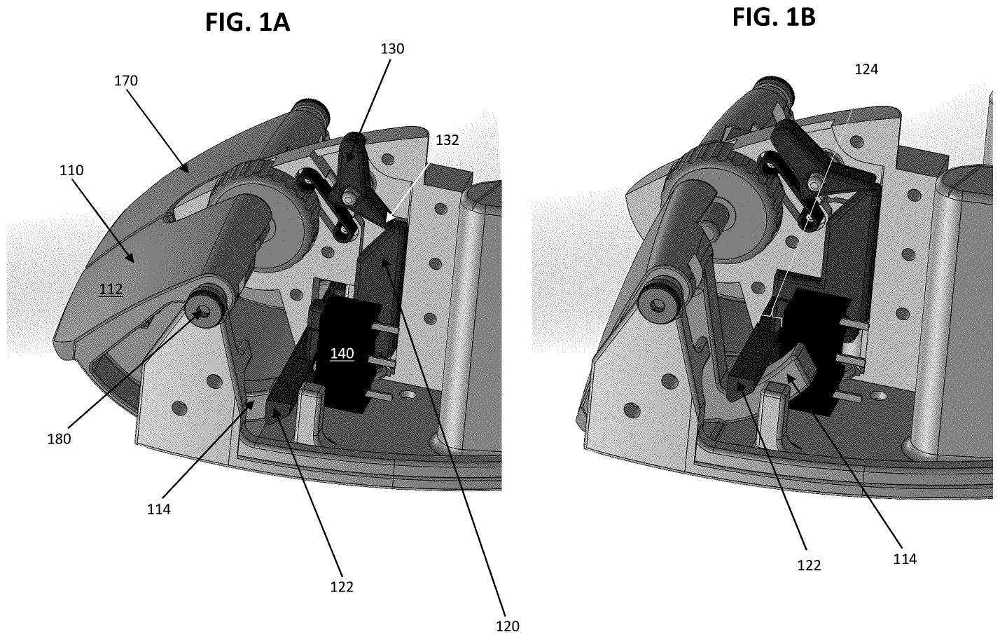

FIG. 1A illustrates an example embodiment of an apparatus that includes a trigger that can function in a variable-input mode and a discrete-input mode. The trigger of FIG. 1A may be integrated into any suitable controller, such as a mouse, an XR (extended reality, which includes AR and VR) controller, a gaming controller, etc. The example apparatus of FIG. 1A includes a trigger 110. Trigger 110 includes an interaction surface 112, with which a user interacts to provide input. For example, a user's finger may press input surface 112 of trigger 110 to provide input using the apparatus. While interaction surface 112 in the example of FIG. 1A is illustrated as having a particular shape and surface area, e.g., similar to that of a mouse button, this disclosure contemplates that any suitable shape or surface area may be used. For example, a trigger may have an interaction area like, or more similar to, a trigger on a gaming controller. A trigger may be a pull trigger, a thumb trigger, or any kind of trigger activated by a hand of a user.

The example of FIG. 1A includes an intermediate switching component (ISC) 120 and a mode selector 130. Mode selector 130 is used to select between a variable input mode for trigger 110 and a discrete input mode for trigger 110. ISC 120 implements the state set by mode selector 130 so that trigger 110 provides input in the selected state. For instance, in the example of FIGS. 1A and 1B, mode selector 130 includes a portion 132 that either pushes into or releases from a corresponding portion of ISC 120. In the example of FIG. 1A, when mode selector 130 is placed in discrete input mode, then portion 132 of mode selector 130 pushes down the corresponding portion of ISC 120. Arm 122 of ISC 120 thus blocks movement of trigger 110 (i.e. prevents rotation of trigger 110 about axis 180). Instead, when a user presses down on interaction surface 112 when mode selector 130 is in discrete mode, then trigger 110 pushes into arm 122 of ISC 120, and a portion of ISC 120 presses into switch 140. This force on switch 140 registers a discrete input, which in particular embodiments, may be similar in movement range and in feel to a mouse click. In the example of FIG. 1A, arm 122 of ISC 120 blocks the beginning portion of trigger 110's range of motion, so that an initial push by the user on trigger 110 results in trigger 110 flexing against 122, which causes ISC 120 to push against and activate switch 140. However, as described herein, an ISC and a switch may occupy other portions of a trigger's range of motion. In addition, while in the example of FIG. 1A ISC 120 moves by flexing slightly to activate switch 140, this disclosure contemplates that an ISC may activate a switch by translating or rotating into the switch.

In the example of FIG. 1A, when mode selector 130 is in variable input mode, then portion 132 of mode selector 130 does not force ISC 120 down, and thus arm 122 moves above internal portion 114 of trigger 110. Trigger 110 can then move freely, without impediment by arm 122, allowing trigger 110 to realize its full movement range (e.g., its full rotation about axis 180). This action is illustrated in FIG. 1B, which shows portion 114 moving freely past arm 122 of ISC 120. Moreover, because portion 114 of trigger 110 does not contact arm 122, switch 140 is not activated, and trigger 110 operates as a variable input without engaging a discrete switch. Therefore, when the example of FIG. 1B is in variable input mode, switch 140 is not activated at all, thereby increasing the life of switch 140 by engaging it only when needed in discrete mode. In addition, switch 140 is stationary (other than the actuation distance required to activate the switch, e.g., 0.4 mm) whether the apparatus is in discrete mode or variable input mode, thereby decreasing the complexity the apparatus and further increasing the reliability and lifespan of switch 140 and related components (e.g., wiring). One result of switch 140 being stationary is that all electronics for switch 140 can be placed on a single printed circuit board, making production of the apparatus of FIG. 1A simpler and more cost effective.

While the examples of FIGS. 1A and 1B illustrate embodiments in which a mode selector forces an ISC down in discrete input mode and the ISC releases upward in variable input mode, this disclosure contemplates that a mode selector may force an ISC down in variable input mode, so that an arm of the ISC moves beneath (and therefore out of the way of) a trigger. The ISC may release upwards in discrete input mode, so that the arm of the ISC moves into the path of the trigger, blocking its full range of motion.

FIG. 1A illustrates an embodiment of a controller that has two separate triggers: trigger 110 and trigger 170. In particular embodiments, ISC 120 may extend to both triggers, and a single mode selector may select the input mode of each trigger simultaneously. The ISC may have two arms, one for each trigger, and each arm may actuate separately in order to activate only that respective trigger's switch. For example, each arm may flex independently of the other in response to force on that arm. For example, a portion of each ISC arm (e.g., portion 124 in the example of FIG. 1B) may be a hollow, two-walled section that acts as a four-bar parallelogram and flexes in response to a force, and therefore does not transmit the force to the other arm, as a fully rigid body would. A one-piece ISC assembly that can service multiple triggers, as shown in the embodiment of FIG. 1, can improve longevity and reduce costs compared to a multi-piece ISC assembly. However, in particular embodiments, each trigger may have its own dedicated ISC and its own dedicated mode selector, e.g., so that each trigger can be placed into an input mode independently of any other trigger.

In particular embodiments, such as the example of FIG. 1A, discrete input may use the beginning of a trigger's range of motion. In the example controller of FIG. 1A, this results in the discrete input simulating a mouse click in direction (i.e., a mouse click is typically nearly straight down, into the mouse) and in range of motion.

As illustrated in the example of FIG. 1A, particular embodiments do not require electronics in the trigger, which helps to ensure trigger longevity by removing any electrical connection from the moving trigger, which may flex wires or cables.

While FIGS. 1A and 1B illustrate a specific example of a mechanical mode selector, this disclosure contemplates that the mode selector may include one or more of a mechanical toggle or switch or an electronic sensor. The mode selector may be an electronic button, a capacitive touch area, a slider, a push button, etc. For example, rather than being a bi-state toggle as shown in the example of FIG. 1A, a mode selector may be a switch or button. In particular embodiments, a mode selector's actuator may be determined by a software setting, which may be changed manually, automatically, or both. For example, a user may select a GUI icon to actuate a mode selector, or may interact with an input (e.g., a capacitive button) on the input device to actuate the mode selector. In particular embodiments, an input device may automatically toggle a mode selector based on a detected use of the input device. For example, when the input device is on a surface (e.g., as detected by an inertial measurement unit or another suitable sensor) then the input device (or a connected device) may toggle a mode selector to discrete input mode, emulating a mouse. When the input device is lifted off the surface, then the input device or a connected device may toggle the mode selector to a variable input mode. In particular embodiments, a mode selector may be electronically toggled based on a use of a connected device. For example, an input device may be an XR controller, and when not on a surface, the input device may default to a variable input mode. However, when the user executes a particular software program on the connected device (e.g., a first-person action game), then the controller may switch to a discrete mode input, at least for one of the triggers on the input device.

While the example of FIG. 1A illustrates ISC 120 as being actuated through physical contact with mode selector 130, this disclosure contemplates that an ISC may be actuated in any suitable manner. For example, the ISC may be actuated (whether rotated or translated) by a solenoid, a motor, a servo, or a hydraulic system. The actuator for the ISC is controlled by the mode selector (e.g., a mode selector in the form of an electronic button may send an electronic signal to a solenoid, which actuates the ISC accordingly), or automatically via software.

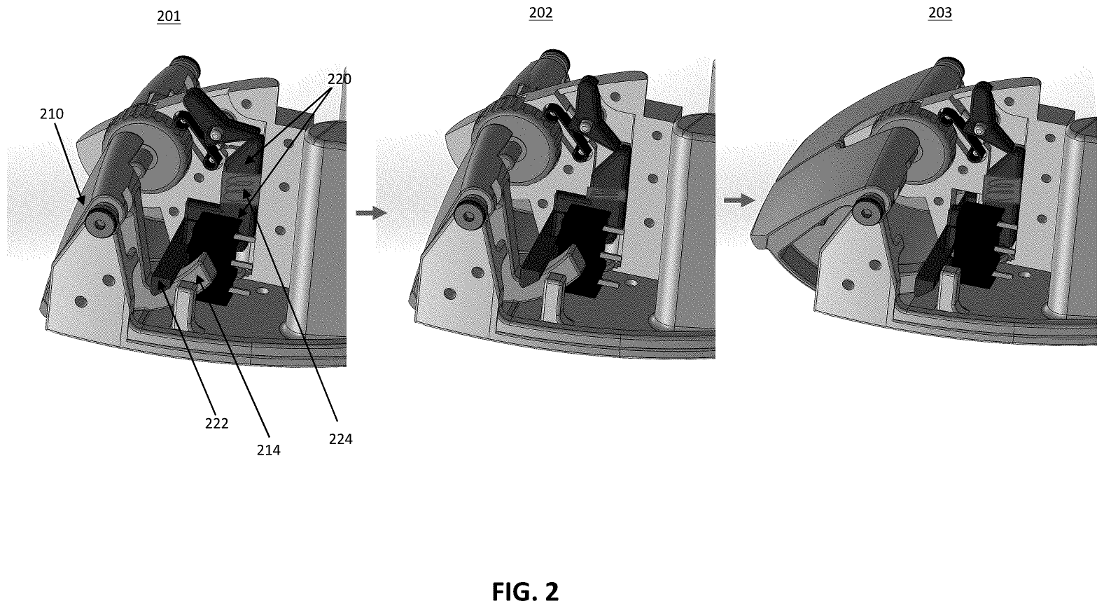

In particular embodiments, an ISC may include a compressible portion, such as a spring, that permits the mode selector to change modes regardless of the state of a trigger. FIG. 2 illustrates an example in which ISC 220 contains a spring 226. In the example of FIG. 1A, if trigger 110 is pressed while in variable input mode, then portion 114 of trigger 110 moves below arm 122, preventing arm 122 from moving into the path of trigger 110 and thereby preventing a user from switching to discrete input mode until trigger 110 is released. However, in the example of FIG. 2, ISC 220 includes a spring 224. As shown in image 202, even when portion 214 of trigger 220 is moved beneath arm 222 in variable input mode, a user can still operate mode selector 230, thereby compressing spring 224. When trigger 210 is released, as shown in image 203, spring 224 forces ISC 220 downward, moving arm 222 into the path of portion 214 of trigger 210, thereby switching trigger 210's input to discrete mode. Thus, a user can toggle mode selector 230 at any time in the example of FIG. 2, even when trigger 210 is being operated in variable input mode.

In particular embodiments, a switch for registering input in a discrete mode may be a microswitch or any other suitable sensor, such as a hall-effect sensor, a time-of-flight sensor, an optical sensor, etc. In particular embodiments, a trigger may be spring loaded or use haptic force feedback. A trigger may use any suitable position-sensing sensor including a potentiometer or a hall-effect sensor, etc. In particular embodiments, a switch for registering input in discrete mode may emulate the feel (e.g., range of motion and haptic “click” sensation) of a mouse click. For example, a switch for the discrete input mode may have a low actuation force and a short actuation distance. In particular embodiments, a trigger may move slightly in discrete input mode, while in other embodiments, the trigger in discrete mode may be stationary, and a haptic/vibration motor may simulate the sensation of a click. Particular embodiments may not use a switch, but instead may provide haptic feedback that simulates the sensation of a switch click, while the input is determined by tracking the movement of the trigger and the position of the ISC, which moves in and out of the path of the trigger. For example, one or more potentiometers or hall-effect sensing may be used to detect trigger position, which along with ISC state, determines whether to provide haptic feedback emulating a switch (e.g., switch-like haptic feedback is provided when ISC is in discrete input mode and a user presses the trigger).

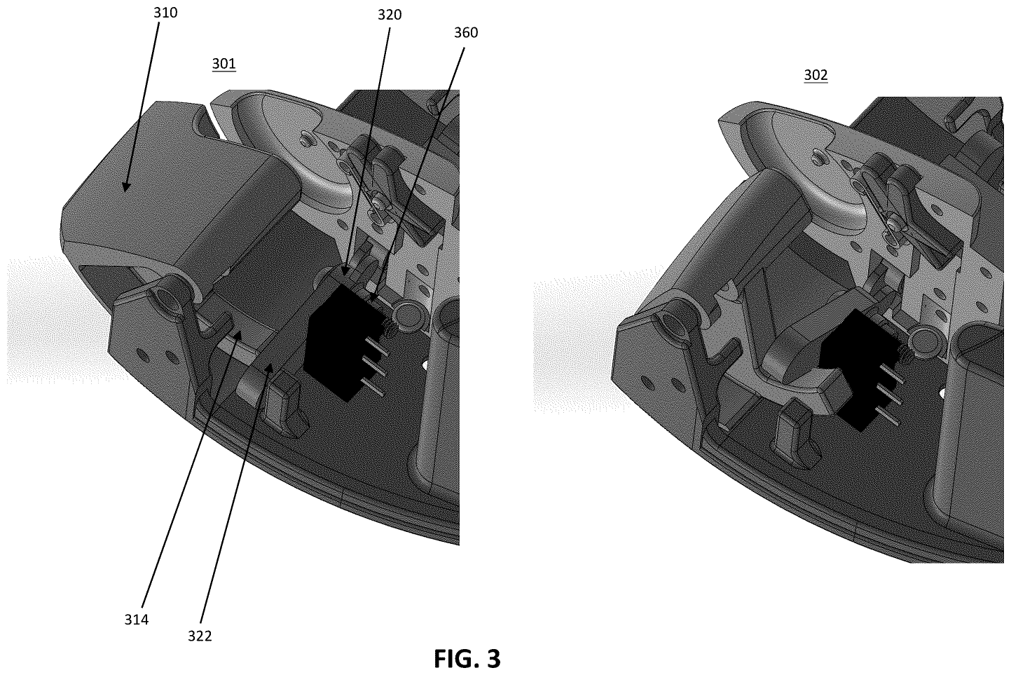

While the example of FIG. 1A illustrates an ISC that switches between input modes by translating in an up-and-down range of motion, this disclosure contemplates that the ISC may move in any suitable direction to switch between states. For instance, FIG. 3 illustrates an example embodiment in which arm 322 of ISC 320 rotates along shaft 360 in order to move into (image 301) and out of (image 302) the path of portion 314 of trigger 310. In particular embodiments, the ISC may rotate along with the arm in order to move between discrete input and variable input modes. In particular embodiments, an arm of an ISC may translate side-to-side or up and down into the path of a trigger.

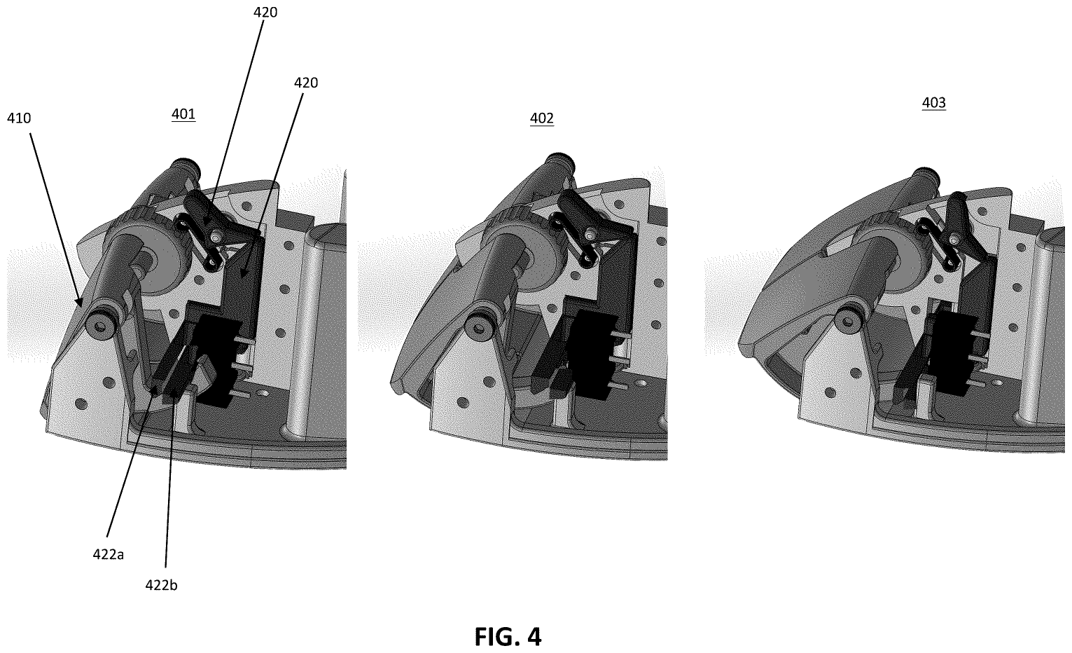

While the example of FIG. 1A illustrates an ISC and a mode selector that has two input modes, this disclosure contemplates that an ISC and mode selector may have three or more input modes. For instance, FIG. 4 illustrates an example of an ISC with three input modes. In the example of FIG. 4, the ISC arm includes two components: portion 422a and portion 422b. Image 401 illustrates a mode in which the arm is completely out of the path of trigger 410, and therefore trigger 410 operates with a full range of motion. Image 402 illustrates a second mode in which the arm has moved down (in this example, through contact with mode selector 430) so that portion 422b is in the path of trigger 410 while portion 422a of the arm is not in the path of trigger 410. Thus, in this second mode, the trigger has an initial range of motion and corresponding initial variable input, and this range of motion ends when trigger 410 contacts the arm, which may engage switch 440. Thus, this second mode includes a variable input followed by a discrete input. In the third mode, illustrated in image 403, ISC 420 is pushed down so that portion 422a of the arm is in the path of trigger 410, resulting in a discrete-input mode analogous to that shown in FIG. 1A.

While the examples above describe modes as starting from the beginning of a trigger's range of motion, this does not necessarily need to be the case. For example, the ISC may have a mode in which it intercepts or restricts the reverse travel of the trigger, thereby creating a mode in which the trigger operates from a partially pressed-in state. For example, when a trigger is pressed in past the half-way point of its range, the ISC may restrict the reverse motion of the trigger (e.g., by moving an arm onto a portion of the trigger, such as portion 114 of the example of FIG. 1B, and catching a “bump” of the portion of the trigger so that the bump cannot move past the arm). The trigger may then operate in a half-pressed to fully-pressed mode. This mode, as well as the other modes discussed throughout, may be set by a user (e.g., by using a mode selector) or automatically by the controller or by software on a connected device. For instance, for a first-person video game, firing the last projectile of a weapon may cause the ISC to enter the half-pressed to full-pressed mode described above, e.g., to indicate to the user that the weapon is empty and needs to be reloaded.

Embodiments of this disclosure may be used in input devices to provide selectable variable input and discrete input from a single input, such as a trigger or button. Example input devices include mice or other controllers, such as gaming controllers, remote controls, XR controllers, etc. A controller may be a hybrid controller capable of operating in multiple modes. For example, a controller may operate in mouse mode when used on a surface as a conventional mouse, and may operate in XR mode when picked up off the surface and used as an XR or gaming controller. For example, a time-of-flight sensor may be used to determine a distance the controller is lifted off a surface, and when the distance is greater than a threshold distance, the controller may automatically switch the trigger to variable-input mode (however, the mode may be manually changed by a user at any time). Embodiments of this disclosure allow the controller to use the same trigger for both discrete input and variable input, allowing a controller to seamlessly switch between a mouse mode and an XR or gaming mode.

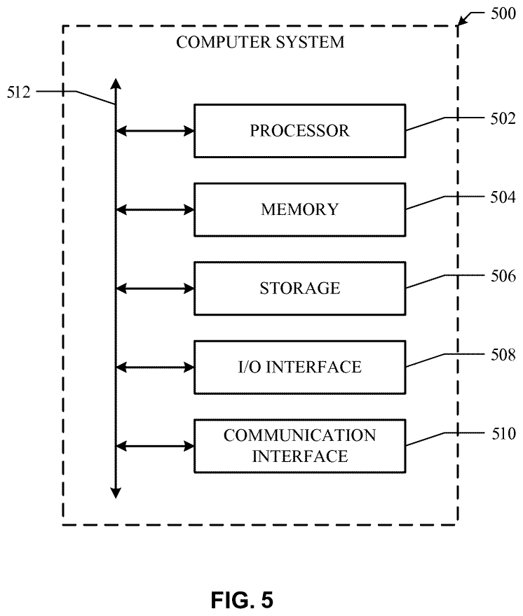

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. An apparatus comprising:
a controller trigger comprising an input surface configured to receive input based on movement of a finger of a user, the trigger having a range of motion along a trigger path;
a mode selector configured to actuate movement of an intermediate switching component (ISC) between a discrete-input mode and a variable-input mode;
the intermediate switching component comprising a moveable arm, wherein:
in the discrete input mode the moveable arm occupies at least a portion of the trigger path, thereby limiting the range of motion of the trigger; and
in the variable input mode the moveable arm does not occupy the trigger path; and
a switch configured to receive input, in the discrete-input mode, based on a movement of the intermediate switching component in response to a physical contact by the trigger.

2. The apparatus of claim 1, wherein the trigger comprises a trigger of an XR controller.

3. The apparatus of claim 1, wherein the trigger comprises a trigger of a mouse.

4. The apparatus of claim 1, wherein the mode selector is configured to actuate movement of the intermediate switching component by motion of the mode selector that causes physical contact between the mode selector and the intermediate switching component.

5. The apparatus of claim 1, wherein the mode selector is configured to translate or rotate the ISC to switch between the discrete input mode and the variable input mode.

6. The apparatus of claim 1, wherein the mode selector is configured to actuate movement of the intermediate switching component by generating an electrical signal that activates an electronic actuator configured to move the intermediate switching component.

7. The apparatus of claim 1, wherein the switch does not occupy any portion of the trigger path.

8. The apparatus of claim 7, wherein the switch is stationary relative to the controller.

9. The apparatus of claim 1, further comprising a compressible material between a first portion of the intermediate switching component and a second portion of the intermediate switching component, wherein the mode selector is configured to actuate the first portion of the intermediate switching component and the second portion of the intermediate switching component comprises the arm.

10. The apparatus of claim 9, wherein the compressible material comprises a spring.

11. The apparatus of claim 1, wherein in the discrete input mode the moveable arm occupies a beginning portion of the trigger path.

12. The apparatus of claim 1, wherein the discrete input mode comprises a plurality of input modes comprising:
a first discrete input mode in which the moveable arm occupies a beginning portion of the trigger path; and
a second discrete input mode in which the moveable arm occupies a portion of the trigger path other than the beginning portion of the trigger path, so that in the second discrete input mode, the trigger has a reduced range of motion along the trigger path that is less than a full range of motion.

13. The apparatus of claim 1, wherein the variable input mode comprises a plurality of variable input modes, each of the plurality of variable input modes corresponding to a different range of trigger motion.

14. The apparatus of claim 1, wherein the intermediate switching component does not include an electrical component.

15. The apparatus of claim 1, further comprising:
a second controller trigger comprising a second input surface configured to receive input based on movement of a finger of the user, the second controller trigger having a range of motion along a second trigger path;
a second moveable arm coupled to the intermediate switching component; and
a second switch configured to receive input from the second controller trigger, wherein the arm and the second arm of the intermediate switching component are each configured to flex independently in response to contact from that arm's respective controller trigger.

16. The apparatus of claim 1 further comprising one or more non-transitory computer readable storage media storing instructions; and one or more processors coupled to the non-transitory computer readable storage media, the one or more processors operable to execute the instructions to:
determine, based on output from a sensor of the controller, a distance of the controller from a surface;
compare the determined distance to a threshold distance; and
automatically actuate the intermediate switching component between input modes based on the comparison.

17. The apparatus of claim 16, wherein the discrete input mode corresponds to determined distances that are less than the threshold distance and the variable input mode corresponds to determined distances that are greater than the threshold distance.

18. The apparatus of claim 16, wherein the sensor comprises a time-of-flight sensor.

19. The apparatus of claim 1 further comprising one or more non-transitory computer readable storage media storing instructions; and one or more processors coupled to the non-transitory computer readable storage media, the one or more processors operable to execute the instructions to:
access information regarding a process executing on a computing device connected to the apparatus; and
automatically adjust the input mode based on the accessed information.

20. The apparatus of claim 19, wherein the accessed information comprises an identification by the process of a particular input mode.
